(19) United States
(12) Patent Application Publication
(10) Pub. No.: US 2008/0041193 A1
(43) Pub. Date: Feb. 21, 2008

(54) Wrench Socket With Multiple Diameters

(75) Inventor: David R. Baker, Crowley, TX (US)

Correspondence Address: BRACEWELL & GIULIANI LLP, P.O. BOX 61389, HOUSTON, TX, 77208-1389, US

(73) Assignee: David Baker, Inc., Crowley, TX (US)

(21) Appl. No.: 11/836,482

(22) Filed: Aug. 9, 2007

Related U.S. Application Data
(60) Provisional application No. 60/837,998, filed on Aug. 16, 2006.

(51) Int. Cl. B25B 13/06

(52) U.S. Cl. 81/124.6

(57) ABSTRACT

A wrench socket assembly has outer and inner sleeves. Each sleeve has a socket drive cavity at each end. The four socket cavities are of different sizes for driving different sizes of fasteners. The outer sleeve has a central section between its socket cavities that slidably receives the inner sleeve. The inner sleeve and the outer sleeve have a torque transmitting feature to allow the inner sleeve to transmit torque through the central section to the outer sleeve. The inner sleeve has a drive section centrally located between its socket cavities. A conventional extension bar from a socket wrench will engage the central drive section located within the inner sleeve.

### CROSS-REFERENCE TO RELATED APPLICATION

This application claims priority to provisional application No. 60/837,998, filed Aug. 16, 2006.

### FIELD OF THE INVENTION

This invention relates in general to socket wrenches, and in particular to a wrench having a socket that is adjustable to multiple nut and bolt head sizes.

### BACKGROUND OF THE INVENTION

A typical socket wrench has a handle and a drive head, which may be a ratchet-type or non-ratchet type. The socket wrench has a drive member on its end that is normally square and inserts into a recess in the base of the socket. The socket has a cylindrical sleeve extending from the base, the sleeve having an internal polygonal socket drive cavity for engaging a fastener, such as a bolt head or nut. The socket drive cavity may be hexagonal or have twelve curved splines, but normally fits only one size of a fastener.

One frequent problem that users experience is losing one or more sockets from the set. The sockets are typically stored in a compartment or tray until use, and the user may forget to return the socket to the tray after use. Also, since only one socket connects to the socket wrench at one time, a user might experience the need for a different size socket but the tray containing the sockets is inconvenient. For example, the user may be working underneath a vehicle with one socket attached to the socket wrench and needing another that is located in a tray in a toolbox that is not under the vehicle.

### SUMMARY OF THE INVENTION

In this invention, a socket assembly is provided that includes inner and outer sleeves. The outer sleeve has socket drive cavities at each end for engaging bolt or nut heads. One of the socket drive cavities is sized to engage a larger diameter fastener than the other. The outer sleeve also has an internal central section between the drive cavities. An inner sleeve fits slidably within the outer sleeve. The inner sleeve has an exterior surface that slidably engages the central section of the outer sleeve. The central section and the exterior surface are configured to transmit torque from the inner sleeve to the outer sleeve.

The inner sleeve has socket drive cavities at both its ends for engaging fasteners. One of the socket drive cavities is a different size than the other. Further, the socket drive cavities on the inner sleeve are different sizes from those on the outer sleeve. The assembly thus has four different sizes of socket drive cavities. The inner sleeve has a square drive section that is located within the inner sleeve between its socket drive cavities. A conventional extension bar of a socket wrench will pass through either end into engagement with the drive section.

The inner sleeve can slide longitudinally within the outer sleeve to provide the socket assembly with three positions. In a first position, the second socket cavity of the outer sleeve is exposed. In a second position, the first socket cavity of the outer sleeve is exposed. In a third position, the ends of the inner sleeve are flush with the ends of the outer sleeve, and both of the outer sleeve socket cavities are blocked by the inner sleeve.

### BRIEF DESCRIPTION OF THE DRAWINGS

FIG. 1 is a schematic, partially exploded sectional view of a socket wrench and a socket assembly constructed in accordance with the present invention, with an inner sleeve in a first position.

FIG. 2 is a sectional view of the socket assembly of FIG. 1 taken along line 2-2 of FIG. 1.

FIG. 3 is a sectional view of the socket assembly of FIG. 1 taken along line 3-3 of FIG. 1.

FIG. 4 is a longitudinal sectional view of the socket of FIG. 1, showing the inner sleeve in a second position.

FIG. 5 is longitudinal sectional view of inner sleeve of the socket assembly of FIG. 1, shown removed from the outer sleeve.

FIG. 6 is a longitudinal sectional view of the outer sleeve of the socket assembly of FIG. 1.

FIG. 7 is a side elevational view of the inner sleeve of the socket assembly of FIG. 1.

### DETAILED DESCRIPTION OF THE INVENTION

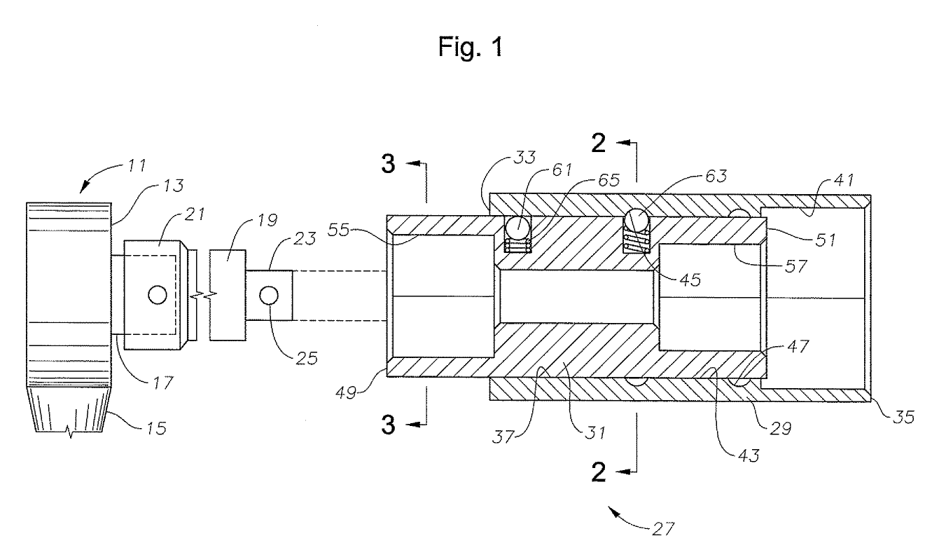

Referring to FIG. 1, socket wrench 11 may be conventional, having a ratcheting head 13 and a handle 15. A drive member 17 that is normally square protrudes from one side of ratcheting head 13. Ratcheting head 13 allows the user to apply torque to drive member 17 in one direction to drive a fastener, such as a bolt head or nut, but to freely rotate handle 15 in the opposite direction without rotating drive member 17.

An extension bar 19 is normally used with this invention. Extension bar 19 may also be conventional and comes in a variety of lengths. Extension bar 19 has a socket drive member 21 at one end that snaps over socket wrench drive member 17. The opposite end has a drive member 23 that is identical to ratcheting head drive member 17. Normally a detent ball 25 is mounted to extension bar drive member 23 to releasably retain a socket.

Socket assembly 27 has four different sizes of sockets in the preferred embodiment for engaging four different sizes of fasteners. Socket assembly 27 has an outer sleeve 29 and an inner sleeve 31, Although inner sleeve 31 can be readily removed from outer sleeve 29, preferably they are maintained together during storage and most operations. Outer sleeve 29 has a longitudinal axis with a first end 33 and a second end 35.

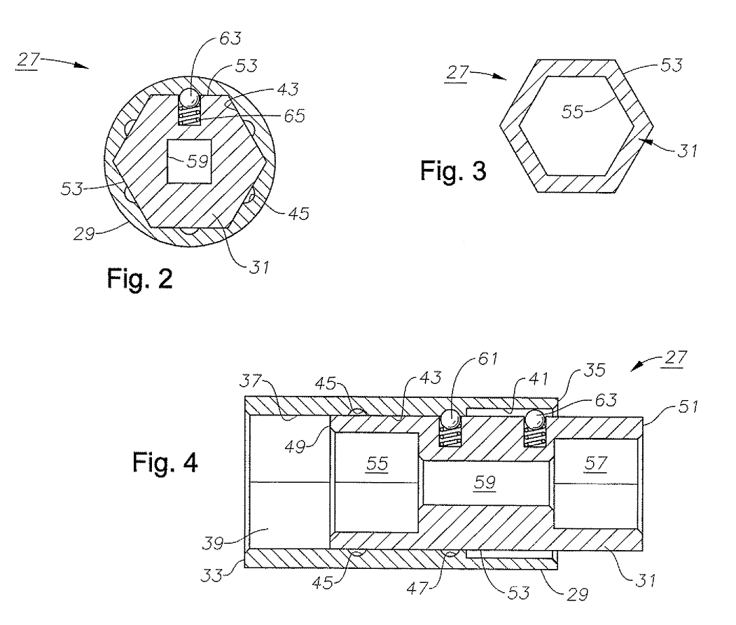

A conventional first socket cavity 37 is located at first end 33. Socket cavity 37, as shown in FIG. 2, has polygonal drive flanks or surfaces 39 arranged around the longitudinal axis. Drive flanks 39 are illustrated to be hexagonal in configuration for engaging a hexagonal fastener. Alternately, they could be of another configuration for either a hexagonal fastener or other types of fasteners. For example, socket cavity 37 could have twelve curved drive flanks, such as a twelve-point socket, rather than the six-point socket shown, both of which fit with hexagonal fasteners. A second socket cavity 41 is located at second end 35. Preferably, second socket cavity 41 is sized for a different fastener than first socket cavity 37. In this embodiment, the second socket cavity 41 is sized for a larger fastener than first socket cavity 37, but it could be smaller. Second socket cavity 41 is also conventional in configuration.

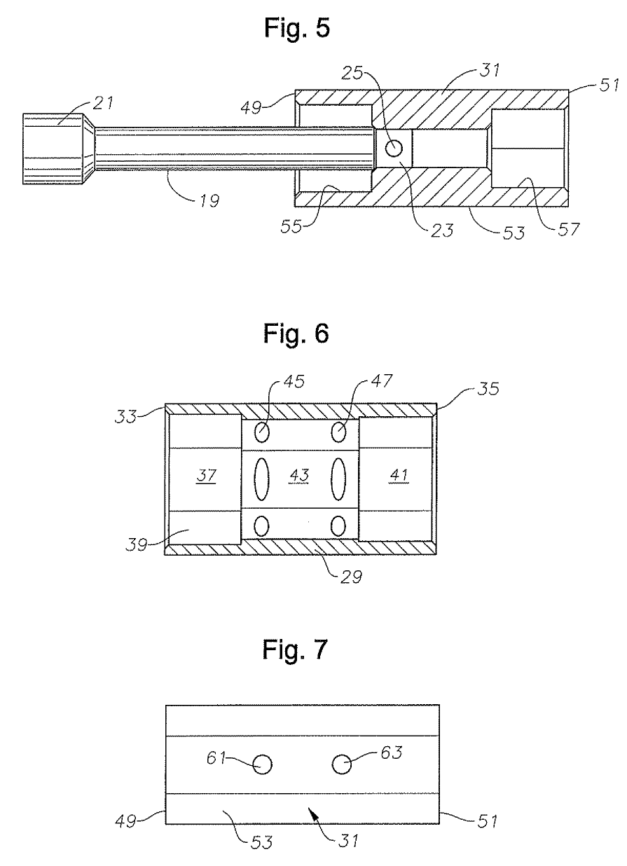

Referring to FIG. 5, a central section 43 is located within outer sleeve 29 between first and second socket cavities 37, 41. Central section 43 has a length that may be at least as long or longer than the longitudinal length of either socket cavity 37 or 41. Central section 43 is not normally employed to directly drive a fastener, however it must have the ability to transmit torque to outer sleeve 29. In this embodiment, this requirement is handled by providing central section 43 with polygonal drive flanks that are hexagonal as shown in FIG. 2. Also, preferably central section 43 has a size or diameter that is at least equal to the smaller of the two socket cavities 37, 41, which is socket cavity 41 in this example. As shown in FIG. 6, in this embodiment, central section 43 has virtually the same cross-sectional configuration as second socket cavity 41, thus appears basically as an extension of second socket cavity 41.

Inner sleeve 31 and outer sleeve 29 have a detent mechanism to releasably retain inner sleeve 31 in a first position shown in FIG. 1, a second position shown in FIG. 4, and a third position (not shown). In the third position, inner sleeve 31 is fully recessed within outer sleeve 29. The detent mechanism may be of a variety of types. As shown in FIG. 6, part of the detent mechanism in this example includes a first row of detent recesses 45 and a second row of detent recesses 47. Each detent recess 45, 47 is located on a separate drive flank of central section 43, as shown in FIG. 2. Each detent recess 45, 47 is generally elliptical in the preferred embodiment, as shown in FIG. 6. Some of the detent recesses 45, 47 appear circular in FIG. 6, but that is due to the angle of the view. The minor axis of the ellipse formed in each recess 45 is parallel with the longitudinal axis of outer sleeve 29, The major axis is perpendicular to the longitudinal axis. The center point of each recess 45 is located in a plane perpendicular to the longitudinal axis, and the center point of each recess 47 is located in a plane perpendicular to the longitudinal axis. The first row of detent recesses 45 is located close to first socket cavity 37. The second row of detent recesses 47 is located close to second cavity 41. The longitudinal distance between rows 45, 47 is at least equal to the longitudinal length of socket cavity 37 or socket cavity 41.

Referring again to FIG. 1, inner sleeve 31 has a first end 49 and a second end 51. Preferably the distance between first and second ends 49, 51 is the same as the distance between first and second ends 33, 35 of outer sleeve 29. Inner sleeve 31 has an exterior surface 53 that mates with the interior surface of outer sleeve central section 43 so as to transmit torque from inner sleeve 31 to outer sleeve 29. In this example, exterior surface 53 is hexagonal, as shown in FIG. 2. Exterior surface 53 extends in a hexagonal form from first end 49 to second end 51. Because the diametrical dimension of exterior surface 53 is smaller than outer sleeve second socket cavity 41 and substantially equal to outer sleeve first cavity 37, inner sleeve 31 can be inserted into outer sleeve 29 from either first end 33 or second end 35.

Inner sleeve 31 has a first socket cavity 55 at first end 49 and a second socket cavity 57 at second end 51. In this example, socket cavity 55 is larger in diameter than socket cavity 57. However, inner sleeve 31 can be inserted in a reverse direction so that first socket cavity 55 would actually be located at the second end 35 of outer sleeve 29. First and second socket cavities 55, 57 are also conventional in configuration and are illustrated to be hexagonal. Inner sleeve 31 has a central drive section 59 that is located between socket cavities 55, 57. In this example, central drive section 59 has a longer axial length than either socket cavity 55 or 57. Central drive section 59 has a square configuration for receiving drive member 23 of extension bar 19. The square configuration has a diagonal dimension that is smaller than the diametrical dimensions of either first or second socket cavities 55, 57. The term “diametrical dimension” is used herein to mean a distance from one point or corner to the one directly opposite.

Inner sleeve 31 has first and second detent balls 61, 63 in this embodiment. First detent ball 61 is located near first socket 55. Second detent ball 63 is located near second socket 57. First and second detent balls 61, 63 are spaced longitudinally apart from each other the same distance as first and second rows 45, 47 of detent recesses (FIG. 6). Providing detent recesses 45, 47 on each of the flanks allows a user to insert inner sleeve 31 into outer sleeve 29 without having to orient detent balls 61, 63 with any particular detent recesses 45, 47. Alternately, only a single detent recess 45 and a single detent recess 47 would work, but orientation would be required. As shown in FIGS. 1, 2 and 4, each detent ball 61, 63 is conventional in that it is installed within a cavity formed in exterior surface 53, A spring 65 urges each ball 61, 63 outward. Preferably a lip at the exterior of each ball-containing cavity will prevent balls 61, 63 and spring 65 from dislodging from the cavity, but will allow the ball to protrude from the exterior sufficiently to engage one of the detent recesses 45, 47.

In use, FIG. 1 illustrates a first position wherein second detent ball 63 engages one of the first row detent recesses 45. First detent ball 61 will be out of engagement with any of the detent recesses 45 or 47. Extension bar 19 will extend through inner sleeve first socket cavity 55 into engagement with central drive section 59. Either before or after inserting extension bar 19, the user positions inner sleeve 31 such that second detent ball 63 snaps into engagement with one of the first detent recesses 45. In this position, inner sleeve first end 49 will protrude past outer sleeve first end 33. Inner sleeve second end 51 will be recessed into outer sleeve central section 43. This exposes outer sleeve second socket cavity 41. The user can place outer sleeve second cavity 41 over a fastener and drive it to either tighten or loosen it. Similarly, while in the position of FIG. 1, the user could insert extension bar 19 through second end 35, which would expose inner sleeve first socket cavity 55. The operator could rotate extension bar 19 with socket wrench 11 to drive a fastener located within inner sleeve first socket cavity 55.

In the second position shown in FIG. 4, the operator has moved inner sleeve 31 such that its second end 51 protrudes past outer sleeve second end 35. While in the second position, first detent ball 61 will be engaging one of the second row detent recesses 47. Second detent ball 63 will be out of engagement with any of the detent recesses 45 or 47. In this position, outer sleeve first socket cavity 37 is exposed for driving a fastener. The user would preferably insert extension bar 19 from the right side, through inner sleeve second cavity 57 into engagement with central drive section 59. Alternately, the operator could insert extension bar 19 from the left side, through both outer sleeve first socket cavity 37 and inner sleeve first socket cavity 55 into engagement with central drive section 59. In that instance, the operator could utilize inner sleeve second socket cavity 57.

A third position, which is not shown, involves positioning inner sleeve 31 such that its ends 49, 51 are substantially flush with outer sleeve ends 33, 35. That position could be used by the user when wishing to utilize only the socket cavities 55, 57 of inner sleeve 3 1. That position would also typically be a storage position. In the third position, first detent ball 61 engages one of the first row of detent recesses 45, and second detent ball 63 engages one of the second row of detent recesses 47.

In addition, as shown in FIG. 5, if desired, the user can push inner sleeve 31 completely from outer sleeve 29 and use inner sleeve 31 by itself. As shown in FIG. 5, second socket cavity 57 is exposed for engaging a fastener. If the fastener is inserted from the right side, first socket cavity 55 would be exposed for engaging driving a fastener. Alternately, when inner sleeve 31 is detached from outer sleeve 29, a user could place an open-end or ratchet box-end wrench around the exterior of inner sleeve 31 and drive inner sleeve 31 by engaging the hexagonal exterior surface 53 of inner sleeve. 31.

Although not shown, a portion of the exterior surface of outer sleeve 29 at first end 33, second end 35, or both ends, could have a hexagonal exterior. This feature would allow a user to use an open-end or ratchet box-end wrench on the hexagonal exterior portion to drive outer sleeve 29 and inner sleeve 31 if contained within outer sleeve 29.

The invention has significant improvements. The assembly is not much larger than a conventional single sized socket, and it provides four different socket sizes. The multiple sizes allow a user to have at hand multiple socket sizes without having to return to a tool box. Also, coupling the sleeves together reduces the likelihood of losing one more of the sockets.

While the invention has been shown in only one of its forms, it should be apparent to those skilled in the art that it is not so limited but is susceptible to various changes without departing from the scope of the invention.

I claim:

1. A wrench socket assembly, comprising:
an outer sleeve having socket drive cavities at first and second ends for engaging fasteners, one of the socket drive cavities being sized to engage a larger diameter fastener than the other, the outer sleeve having an internal central section between the socket drive cavities;
an inner sleeve that fits within the outer sleeve, the inner sleeve having an exterior surface that slidably engages the central section of the outer sleeve, the central section and the exterior surface being configured to transmit torque from the inner sleeve to the outer sleeve;
the inner sleeve having socket drive cavities at first and second ends for engaging fasteners, one of the socket drive cavities of the inner sleeve being sized to engage a larger diameter fastener than the other socket drive cavity of the inner sleeve; and
a square drive section located within the inner sleeve between its socket drive cavities for receiving and being driven by an extension bar.

2. The assembly according to claim 1, wherein the inner sleeve has a first position wherein its first end protrudes past the first end of the outer sleeve and its second end is recessed within the central section to provide access to the socket drive cavity on the second end of the outer sleeve.

3. The assembly according to claim 1 wherein the inner sleeve has a second position wherein its second end protrudes past the second end of the outer sleeve and its first end is recessed within the central section to provide access to the socket drive cavity on the first end of the outer sleeve.

4. The assembly according to claim 1, wherein the inner sleeve has a third position wherein its ends are substantially flush with the ends of the outer sleeve.

5. The assembly according to claim 1, wherein the central section has a plurality of drive flanks spaced circumferentially around the central section, and the exterior surface of the inner sleeve comprises a plurality of drive flanks that slidably mate with the drive flanks of the central section to transmit torque from the inner sleeve to the outer sleeve.

6. The assembly according to claim 1, wherein;
the central section has drive flanks that are substantially the same size and configuration as the socket drive cavity on the first end of the outer sleeve; and
the exterior surface of the inner sleeve comprises a plurality of drive flanks that slidably mate with the socket drive cavity on the first end of the outer sleeve and the drive flanks in the central section.

7. The assembly according to claim 1, wherein:
each of the socket drive cavities of the inner and outer sleeves and the central section of the outer sleeve has at least six drive flanks; and
the exterior surface of the inner sleeve is hexagonal.

8. The assembly according to claim 1, wherein:
the inner sleeve is longitudinally slidable between a first position wherein its first end protrudes past the first end of the outer sleeve and the socket drive cavity on the second end of the outer sleeve is exposed, a second position wherein the second end of the inner sleeve protrudes past the second end of the outer sleeve and the socket drive cavity on the first end of the outer sleeve is exposed, and a third position wherein the first end of the inner sleeve is flush with the first end of the outer sleeve and the second end of the inner sleeve is flush with the second end of the outer sleeve; and
mating detent members are located in the central section and on the exterior surface for releasably retaining the inner sleeve in the first, second and third positions.

9. The assembly according to claim 1, wherein the inner sleeve is insertable into and removable from the outer sleeve from the first end and from the second end of the outer sleeve.

10. A wrench socket assembly, comprising:
an outer sleeve having a longitudinal axis and first and second ends;
socket drive cavities at the first and second ends of the outer sleeve for engaging fasteners, one of the socket drive cavities being a larger diametrical size than the other socket drive cavity;
an internal central section between the socket drive cavities, the central section comprising a plurality of drive flanks spaced circumferentially around the longitudinal axis, the central section having a diametrical size no larger than the smaller of the socket drive cavities;
an inner sleeve that fits within the outer sleeve and has substantially the same length as the outer sleeve, the inner sleeve having a polygonal exterior surface that slidably engages the central section of the outer sleeve to transmit torque to the outer sleeve;
the inner sleeve having first and second ends with socket drive cavities at its ends for engaging fasteners, one of the socket drive cavities having a larger diametrical size than the other socket drive cavity of the inner sleeve;
an internal square drive section located within the inner sleeve between its socket drive cavities for receiving and being driven by an extension bar, the square drive section having a diagonal dimension smaller than the diametrical dimensions of the socket drive cavities of the inner sleeve;
the inner sleeve being longitudinally slidable relative to the outer sleeve between a first position wherein its first end protrudes past the first end of the outer sleeve and the socket drive cavity on the second end of the outer sleeve is exposed, a second position wherein the second end of the inner sleeve protrudes past the second end of the outer sleeve and the socket drive cavity on the first end of the outer sleeve is exposed, and a third position wherein the first end of the inner sleeve is flush with the first end of the outer sleeve and the second end of the inner sleeve is flush with the second end of the outer sleeve; and
a detent member in the central section of the outer sleeve that mates with a detent member on the exterior surface of the inner sleeve for releasably retaining the inner sleeve in the first, second and third positions.

11. The assembly according to claim 10, wherein the inner sleeve is insertable into and removable from the outer sleeve from the first end and from the second end of the outer sleeve.

12. The assembly according to claim 10, wherein:
the socket drive cavities of the inner and outer sleeves and the central section of the outer sleeve each have at least six drive flanks; and
the exterior surface of the inner sleeve is hexagonal.

13. The assembly according to claim 10, wherein:
the central section has substantially the same configuration and diametrical size as the smaller of the socket drive cavities of the outer sleeve.

14. The assembly according to claim 10, wherein:
the central section has an axial length at least as long as the socket drive cavities of the outer sleeve.

15. The assembly according to claim 10, wherein the detent member on the inner sleeve comprises a spring-biased ball, and the detent member on the outer sleeve comprises a recess for engagement by the ball.

16. The assembly according to claim 10, wherein:
the detent members on the inner sleeve comprise first and second spring-biased balls longitudinally spaced apart;
the detent members on the outer sleeve comprise first and second recesses formed in the central section and longitudinally spaced-apart;
in the first position, the second spring-biased ball engages the first recess;
in the second position, the first spring-biased ball engages the second recess; and
in the third position, the first and second spring-biased balls engage the first and second recesses, respectively.

17. A method of driving a fastener, comprising:
providing an outer sleeve having socket drive cavities at first and second ends for engaging fasteners and an internal central section between the socket drive cavities having a torque-transmitting member;
providing an inner sleeve having socket drive cavities at first and second ends for engaging fasteners and an internal drive bar section between the socket drive cavities;
inserting the inner sleeve into the outer sleeve and mating an exterior surface of the inner sleeve with the torque-transmitting member;
moving the inner sleeve to a first position relative to the outer sleeve to expose the socket drive cavity on the second end of the outer sleeve;
inserting an extension bar through the first end of the inner sleeve into the internal drive bar section, placing the socket drive cavity at the second end of the outer sleeve on a fastener and rotating the extension bar and the inner and outer sleeves to rotate the fastener; then
moving the inner sleeve to a second position relative to the outer sleeve to expose the socket drive cavity on the first end of the outer sleeve;
inserting the extension bar through the second end of the inner sleeve into the internal drive bar section, placing the socket drive cavity at the first end of the outer sleeve on a second fastener and rotating the extension bar and the inner and outer sleeves to rotate the second fastener.

18. The method according to claim 17, further comprising
inserting the extension bar through the first end of the inner sleeve into the internal drive bar section, placing the socket drive cavity at the first end of the inner sleeve on a third fastener and rotating the extension bar and the inner and outer sleeves to rotate the third fastener; then
inserting the extension bar through the second end of the inner sleeve into the internal drive bar section, placing the socket drive cavity at the second end of the inner sleeve on a fourth fastener and rotating the extension bar and the inner and outer sleeves to rotate the fourth fastener.

19. The method according to claim 17, wherein the socket drive cavities of the outer sleeve and the inner sleeve have differential diametrical dimensions.
